(19) United States
(12) Patent Application Publication
(10) Pub. No.: US 2026/0252471 A1
(43) Pub. Date: Aug. 27, 2026

(54) COMPONENT-BASED SCHEDULING AND RELEASE READINESS DETERMINATION

(71) Applicant: Microsoft Technology Licensing, LLC, Redmond, WA (US)

(72) Inventors: Yingying CHEN, Kirkland, WA (US); Josh Charles MOORE, Lynnwood, WA (US); Amitabh NAG, Redmond, WA (US); James WOOLDRIDGE, Fall City, WA (US); Senthilkumar VELUSWAMI, Bothell, WA (US); Ahu PERSEMBE, Kirkland, WA (US); Akshay Sudhir BAPAT, Bothell, WA (US); Irina KRAVSOV, Snoqualmie, WA (US); Madeleine FRANKE, New York, NY (US); Fernando Andrés PIERESSA PIZARRO, Seattle, WA (US); Julien DAOUPHARS, Seattle, WA (US)

(73) Assignee: Microsoft Technology Licensing, LLC, Redmond, WA (US)

(21) Appl. No.: 19/063,932

(22) Filed: Feb. 26, 2025

(51) Int. Cl. G06F 11/3668; G06F 8/36; G06F 8/41; G06F 11/30

(52) U.S. Cl. CPC G06F 11/3688; G06F 8/36; G06F 8/433; G06F 11/3051; G06F 11/3676; G06F 11/3684

(57) ABSTRACT

Systems and methods are provided for implementing component-based scheduling and release readiness determination. A computing system automatically registers new hardware and virtual machines, establishing dependencies to avoid invalid scenarios. The computing system dynamically generates testing plans by combining reusable components (e.g., shared components) and continuously updates coverage based on existing configurations. In some examples, artificial intelligence (“AI”) tools recommend coverage and scheduling plans to enhance efficiency. Additionally, the computing system utilizes an actionable test scheduling and diagnostics tool, which is based on a product validation standard, that identifies critical configurations, assesses software release readiness, and estimates realistic shipping targets. The actionable test scheduling and diagnostics tool assists users in meeting their software product shipping goals while ensuring reliable product performance and minimizing the validation workload.

### BACKGROUND

A limitation of current software validation processes is that such processes rely heavily on manually creating unique schemas (e.g., Javascript® Object Notation (“JSON”) schemas, extensible Markup Language (“XML”) schemas, or YAML Ain't Markup Language (“YAML”) schemas) for each combination of hardware, virtualized hardware, operating system, software, supporting resources, software applications, and/or other hardware/software/firmware component for a deployment of a program or code update that requires validation (each combination also being referred to herein as “a configuration”). This approach results in significant maintenance overhead, as users must manage numerous schemas (one for each configuration, even if differing in one minor component), complicating the tracking of tested configurations. The redundancies in code across these schemas stemming from shared validation stages creates challenges for updates and increases the risk of errors. The lack of a centralized management system exacerbates these issues, leading to an inefficient and labor-intensive validation process.

Also, in current industry practices, there is a lack of a configuration coverage standard. Current industry practices for software validation primarily rely on code coverage, reliability metrics, latency measurements, and the number of identified bugs to determine a product's release readiness. However, these metrics alone are insufficient. Software running at the platform level can behave differently across different types of hardware or when influenced by external features or dimensions which can expose failure modes which may not reproduce under the typical code coverage methodology. These real-world edge cases involve numerous external factors not anticipated during parts-level tests. There is also an absence of widely adopted metrics for capturing configuration coverage in existing practices. Most existing methodologies use either code coverage or calculate coverage based on the percentage of configurations tested. There is also no existing method to accurately estimate shipping targets given limited time and budget constraints for product testing. That is, there is no established approach that can be leveraged to estimate what is considered sufficient testing for a software product before releasing to customers. Establishing a realistic shipping target can improve decision-making regarding release readiness. There is also a lack of existing tools to enforce shipping targets effectively.

It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for component-based scheduling and release readiness determination.

The present technology provides a more streamlined and centralized solution that enhances usability and reduces the burden of maintenance. The present technology enables automation and centralization of the validation process for program or code updates, covering various implementation configurations (e.g., combinations) of hardware, virtual machines, operating systems, and/or applications. Users are provided with options to customize their validation processes and schedule scenario validations through an application programming interface (“API”), enabling them to create new validation stages or reuse existing components. The system automatically registers new hardware and virtual machines, establishing dependencies to avoid invalid scenarios. The system dynamically generates testing plans by combining reusable components and continuously updates coverage based on existing configurations. In some examples, AI tools recommend coverage and scheduling plans to enhance efficiency. Additionally, the system utilizes an actionable test scheduling and diagnostics tool, which is based on a product validation standard, that identifies critical configurations, assesses software release readiness, and estimates realistic shipping targets. The actionable test scheduling and diagnostics tool assists users in meeting their product shipping goals while ensuring reliable product performance and minimizing the validation workload.

The details of one or more aspects are set forth in the accompanying drawings and description below. Other features and advantages of the claimed subject matter will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing component-based scheduling and release readiness determination.

FIG. 2A depicts an example graphical representation of coverage percentage targets and measurements over time when implementing release readiness determination.

FIG. 2B depicts an example simulation process when calculating ship target estimates

when implementing release readiness determination.

FIG. 3 depicts an example method for implementing component-based scheduling.

FIGS. 4A and 4B depict an example method for implementing component-based

scheduling and release readiness determination.

FIG. 5 depicts a block diagram illustrating example physical components of a

computing device with which aspects of the technology may be practiced.

### DETAILED DESCRIPTION OF CERTAIN EMBODIMENTS

As briefly discussed above, current solutions for the validation process predominantly rely on scheduling manual validations using a JSON file schema, an XML file schema, or a YAML file schema. This schema, designed with a predefined structure, outlines the various stages to be executed and their specific order. Additionally, it specifies the hardware, virtual machines (“VMs”), and configurations that need validation. This structured approach allows users to define how often they want to repeat the validation on the same configuration (e.g., combination) to analyze reliability and performance. However, the existing method has several drawbacks. For each unique configuration that requires validation, users must create a new schema. This results in a significant amount of unnecessary work and the generation of multiple files. Managing these numerous schemas becomes cumbersome, leading to difficulties in tracing which configurations have been tested and for what specific scenarios. The lack of centralized management and the proliferation of files complicate the validation process and hinder efficient tracking. Moreover, there is a substantial amount of repeated code across different JSON files, different XML files, or different YAML files. Many features or dimensions to be tested share similar stages, leading to redundancy. This repetition not only increases the effort required to maintain and update the schemas but also introduces potential errors and inconsistencies. Shared stages across multiple JSON files, multiple XML files, or multiple YAML files mean that any change in the common stages necessitates updates in all corresponding schemas, further escalating the maintenance workload.

Also, in current industry practices, there is a lack of a configuration coverage standard. Current industry practices for software validation primarily rely on code coverage, reliability metrics, latency measurements, and the number of identified bugs to determine a product's release readiness. However, these metrics alone are insufficient. Software running at the platform level can behave differently across different types of hardware or when influenced by external features or dimensions which can expose failure modes which may not reproduce under the typical code coverage methodology. These real-world edge cases involve numerous external factors not anticipated during parts-level tests (e.g., tests performed on individual parts in a relatively isolated environment that may not replicate real-world scenarios). There is also an absence of widely adopted metrics for capturing configuration coverage in existing practices. Most existing methodologies use either code coverage or calculate coverage based on the percentage of configurations tested. There is also no existing method to accurately estimate shipping targets given limited time and budget constraints for product testing. That is, there is no established approach that can be leveraged to estimate what is considered sufficient testing for a software product before releasing to customers. Establishing a realistic shipping target can improve decision-making regarding release readiness. There is also a lack of existing tools to enforce shipping targets effectively.

The present technology provides for component-based scheduling and release readiness determination. Component, as used herein, refers to each individual feature or dimension that is being tested against, such as specific hardware or a particular VM size. The present technology enables automation and centralization of the validation process for program or code updates, covering various implementation configurations of hardware, virtual machines, operating systems, and/or applications. Users are provided with options to customize their validation processes and schedule scenario validations through an application programming interface (“API”), enabling them to create new validation stages or reuse existing components. The system automatically registers new hardware and virtual machines, establishing dependencies to avoid invalid scenarios. The system dynamically generates testing plans by combining reusable components (e.g., shared components) and continuously updates coverage based on existing configurations, in some cases, by using previously used configurations having the shared components as a basis for a current configuration and modifying portions that differ in terms of the currently different/new component(s) compared with the previously used component(s) in the previously used configurations. In some examples, AI tools recommend coverage and scheduling plans to enhance efficiency. Additionally, the system utilizes an actionable test scheduling and diagnostics tool, which is based on a product validation standard, that identifies critical configurations, assesses software release readiness, and estimates realistic shipping targets. The actionable test scheduling and diagnostics tool assists users in meeting their product shipping goals while ensuring reliable product performance and minimizing the validation workload.

The present technology divides configurations into core configurations and secondary configurations, using business value coverage to measure combinatorial coverage of core configurations, and univariate coverage to assess secondary configurations. The system integrates multiple factors, including validation scope, duration, test execution rate, and capacity limitations in the test infrastructure, to more accurately estimate the shipping target. Beyond evaluating coverage measures and determining a product's release readiness, our project offers tools and methodologies that assist teams in optimizing their coverage and pinpointing test gaps with an AI model that is used as part of the IA tools. The system also breaks down the shipping target into more attainable stage targets. These efforts will assist the team to meet the reliability SLA before the product release.

Various modifications and additions can be made to the embodiments discussed herein without departing from the scope of the disclosed techniques. For I example, while the embodiments described above refer to particular features of the claimed subject matter, the scope of the disclosed techniques also includes embodiments having different combinations of features and embodiments of the claimed subject matter that do not include all of the above-described features of the claimed subject matter.

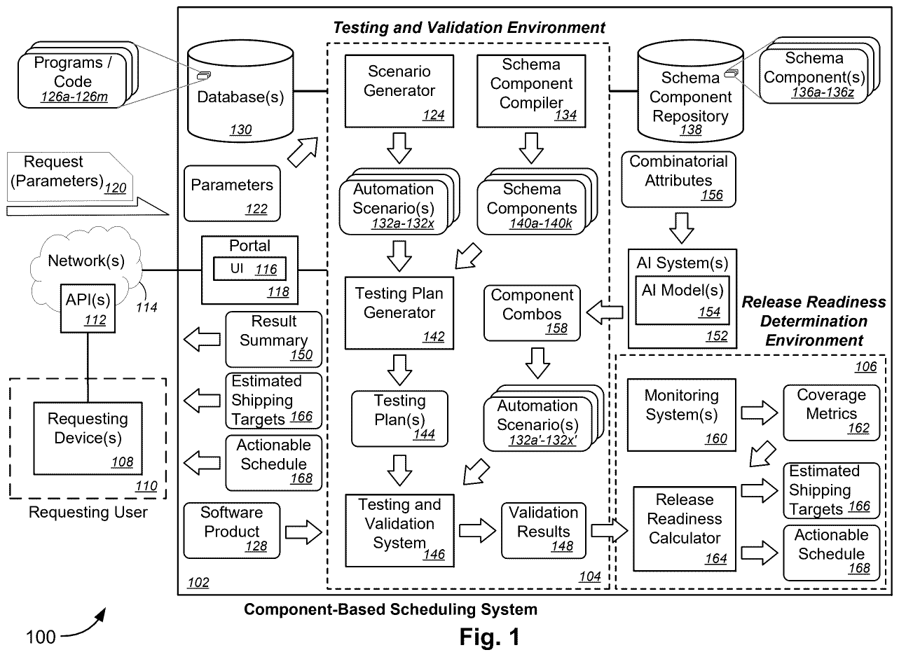

Turning to the embodiments as illustrated by the drawings, FIGS. 1-5 illustrate some of the features of methods, systems, and apparatuses for implementing component-based scheduling and release readiness determination, as referred to above. The methods, systems, and apparatuses illustrated by FIGS. 1-5 refer to examples of different embodiments that include various components and steps of the claimed subject matter, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing component-based scheduling and release readiness determination. System 100 includes a component-based scheduling system 102, which includes a testing and validation environment 104 and a release readiness determination environment 106. In examples, the component-based scheduling system 102, which is used to test and validate features or dimensions of software products before they are deployed for use, is implemented in a server node, in a VM, or in a container. System 100 further includes a requesting device(s) 108 associated with or used by a requesting user 110. In examples, requesting device(s) 108 communicatively couples with component-based scheduling system 102 via application programming interface(s) (“API(s)”) 112 over network(s) 114, in some cases, via one or more of a user interface (“UI”) 116 and/or a portal 118. In some examples, the requesting device(s) 108 includes one of a desktop computer, a laptop computer, a tablet computer, a smart phone, or a mobile phone. In examples, network(s) 114 each includes at least one of a distributed computing network, such as the Internet, a private network, a commercial network, or a cloud network, and/or the like.

In some aspects, the requesting device(s) 108 sends a request 120 (which is a request to test and validate a software product 128 for deployment) to the component-based scheduling system 102, via API(s) 112 and network(s) 114, and, in some cases, via one or both of UI 116 and/or portal 118. In some examples, the request 120 includes a set of parameters 122 to be used when testing and validating the software product. In examples, the set of parameters 122 includes at least one of platform setup configurations, a listing of eligible hardware for platform setup, VM deployment configurations, a selection of hardware scope to launch, a selection of VM hardware scope to launch, a selection of guest operating system (“OS”) scope to launch, a selection or deselection of workload deployment, VM count numbers, a selection of a hardware architecture, a selection of an OS, a selection of a VM storage type, a selection or deselection of an accelerated network implementation, or a selection of a VM creation type.

Within the testing and validation environment 104, after the component-based scheduling system 102 receives the request 120, the component-based scheduling system 102, using a scenario generator 124, autonomously generates a plurality of automation scenarios 132a-132x that is used to test and validate the software product 128, based on the set of parameters 122. In some examples, the software product 128 is part of a plurality of programs or code 126a-126m that has been stored in database(s) 130, which is either part of component-based scheduling system 102 or external yet communicatively coupled to component-based scheduling system 102. Also within the testing and validation environment 104, the component-based scheduling system 102, using a schema component compiler 134, autonomously compiles a set of validation components (or schema components) 140a-140k for each automation scenario, in some cases, based on schema components 136a-136z that are stored in schema component repository 138. In some examples, the set of validation components 140a-140k includes JSON schema components, XML schema components, or YAML schema components. In some cases, the set of validation components 140a-140k for each automation scenario corresponds to a plurality of stages in a validation process, which includes setting up resources that are used to run the software product, creating a VM, and running code or scripts on the VM. In some instances, one or more validation components 140 among the set of validation components 140a-140k that are shared across multiple automation scenarios 132 among the plurality of automation scenarios 132a-132x are reused for each of the multiple automation scenarios 132 across which the one or more validation components 140 are shared. Further, within the testing and validation environment 104, the component-based scheduling system 102, using a testing plan generator 142, dynamically generates a testing plan(s) 144 for the plurality of automation scenarios 132a-132x, in some cases, based on the set of validation components 140a-140k. Herein, k, m, x, and z are non-negative integer numbers that may be either all the same as each other, all different from each other, or some combination of same and different (e.g., one set of two or more having the same values with the others having different values, a plurality of sets of two or more having the same value with the others having different values).

In examples, the component-based scheduling system 102 receives, via the UI 116, a first user input selecting a platform setup that is used to generate the plurality of automation scenarios 132a-132x. In some cases, the component-based scheduling system 102 receives, via the UI 116, a second user input selecting or creating one or more pre-VM deployment actions. In some instances, the one or more pre-VM deployment actions include at least one of deploying a monitoring service (e.g., monitoring system(s) 160) that monitors deployment of the VM, deploying a hot restart for a hypervisor for a platform on which the VM is deployed to run the software product 128, deploying a hot patch to implement security updates, deploying updates to the VM, or initiating live migration of the VM to another node. In some examples, the component-based scheduling system 102 receives, via the UI 116, a third user input selecting or creating one or more post-VM deployment actions. In some cases, the one or more post-VM deployment actions include at least one of deploying a first input/output (“I/O”) agent for a first OS, deploying a second I/O agent for a second OS, or stopping deployment of the monitoring service. In some instances, the plurality of automation scenarios 132a-132x each includes the platform setup, the one or more pre-VM deployment actions, the deployment of the VM, and the one or more post-VM deployment actions.

In some examples, the component-based scheduling system 102 autonomously generates a scope of coverage in which each automation scenario can be tested and validated, including identifying all existing configurations (e.g., combinations) of hardware, VMs, and other platform components on which the software product 128 can be deployed for each automation scenario. In examples, hardware and VMs that are used to deploy the software product 128 that have not yet been registered are automatically identified and registered by the component-based scheduling system 102. In some cases, autonomously generating the scope of coverage includes or further includes the component-based scheduling system 102 identifying dependencies between each configuration of the hardware, the VMs, and the other platform components. In some instances, autonomously generating the scope of coverage includes or further includes the component-based scheduling system 102 automatically adding or updating the identified dependencies for each configuration in each automation scenario. In some examples, the other platform components include at least one of an OS, software, software applications, or supporting resources.

In examples, autonomously generating the scope of coverage in which each automation scenario can be tested and validated is performed using an artificial intelligence (“AI”) model 154 of AI system(s) 152 that is trained to recommend a plurality of configurations of hardware, VMs, and other platform components based on a selection of combinatorial attributes 156. In some cases, the combinatorial attributes 156 includes two or more of a number of generations of the hardware associated with the VM to launch, computing hardware labelled by particular stock keeping units (SKUs”), VM sizes, a container-based accelerated network (“AN”) being enabled or disabled, remote direct memory access (“RDMA”) features being enabled or disabled, a fast solid state drive (“SSD”)-based storage being enabled or disabled, a data storage system combining SSDs and hard disk drives (“HDDs”) into a single storage pool (“XIO storage”) being deployed, an image publisher, a group of related images created by the image publisher (“image offer”), a component of a VM image (“image SKU”), or other testable combinatorial attributes.

Further, within the testing and validation environment 104, the component-based scheduling system 102, using a testing and validation system 146, implements the testing and validation of the software product 128 to produce validation results 148, in some cases, by running the testing plan(s) 144 across the scope of coverage for each automation scenario among the plurality of automation scenarios 132a-132x. In examples, the component-based scheduling system 102 presents, via the UI 116, a result summary 150 of the testing and validation of the software product 128 for each automation scenario to the requesting device(s) 108 based on the validation results 148, in some cases, via API(s) 112 over network(s) 114. In some examples, the result summary 150 includes at least one of a number of action steps implemented for that automation scenario, a number of launches implemented for that automation scenario, a number of computing hardware launched for that automation scenario, or a number of generations of the hardware associated with the VM that are launched for that automation scenario. In some cases, the UI 116 provides at least one of first options to view individual launches, second options to select one or more generations for a breakdown of the computing hardware launched, or third options to view hardware details for individual launches.

Within the release readiness determination environment 106, the component-based scheduling system 102, using a monitoring system(s) 160, monitors configuration coverage metrics 162 associated with running the testing plan(s) 144 across the scope of coverage for each automation scenario 132. Also, within the release readiness determination environment 106, the component-based scheduling system 102 identifies a critical configuration that is required for product validation of the software product 128, based on the configuration coverage metrics 162. Further, within the release readiness determination environment 106, the component-based scheduling system 102, using a release readiness calculator 164, determines a release readiness of the software product 128 based on the configuration coverage metrics 162 associated with the critical configuration. The component-based scheduling system 102, using the release readiness calculator 164, estimates shipping targets 166 for the software product 128, in some cases, based on a combination of a project budget for development and deployment of the software product 128, available testing resources that are used to test and validate the software product 128, and the release readiness of the software product 128. The component-based scheduling system 102, using the release readiness calculator 164, determines an actionable testing and diagnostics schedule 168 and defining a development process to implement to achieve the shipping targets 166 for the software product 128. The component-based scheduling system 102 presents the estimated shipping targets 166 and/or the actionable testing and diagnostics schedule 168 and the development process that is to be used to achieve the shipping targets 166 for the software product 128 to the requesting device(s) 108, in some cases, via the UI 116 and via API(s) 112 over network(s) 114.

In the manner described above, because the one or more validation components (e.g., schema components 140) that are shared across multiple automation scenarios 132 are reused for each of the multiple automation scenarios 132, the component-based scheduling system 102 avoids creating multiple unique schema components one for each configuration of hardware, virtualized hardware, operating system, software, supporting resources, software applications, and/or other hardware/software/firmware component for deployment of the software product. That is, instead for basing testing and validation of software products on a whole schema file, where even minor changes necessitate creating a whole new unique schema file, the component-based scheduling system 102 focuses on the schema components, and compiles (and shares common) schema components 140 across multiple automation scenarios 132. In this manner, redundancies in code across schema files is avoided, while reducing storage burdens for storing such schema files. In the conventional system, when there are any changes in shared stages across multiple schema files, it is necessary to update all corresponding schemas, which escalates maintenance workloads while potential increasing risks of errors in updating across the multiple schema files. With updates to schema components being reflected in the shared schema components in the component-based scheduling approach, issues for updating and risks of error are reduced, updates to a shared schema component are comparatively quick and efficient (as there is only one schema component to update, and once updated, that shared schema component is reused across the multiple automation scenarios), and maintenance workloads (if any) are minimized. The component-based scheduling system 102 also functions as a centralized management system that increases efficiency in the overall testing and validation environment. The component-based scheduling system also uses configuration coverage as an indicator of release readiness, while establishing well-defined standards for assessing the validation coverage of a new release build across various configurations including generation, computing hardware labelled by SKUs, and VM sizes. In this manner, the component-based scheduling system minimizes incidents and customer escalations in software products before deployment to customers.

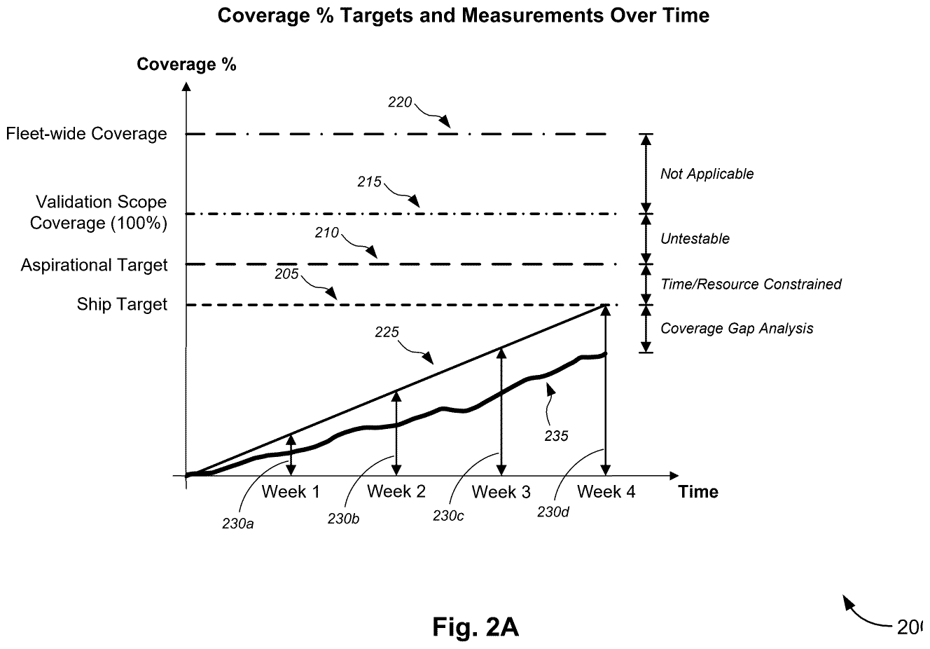

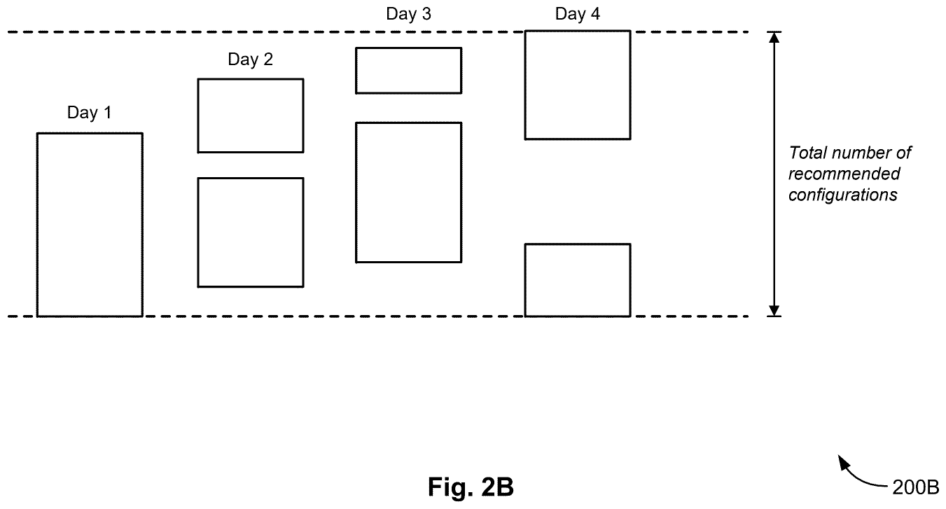

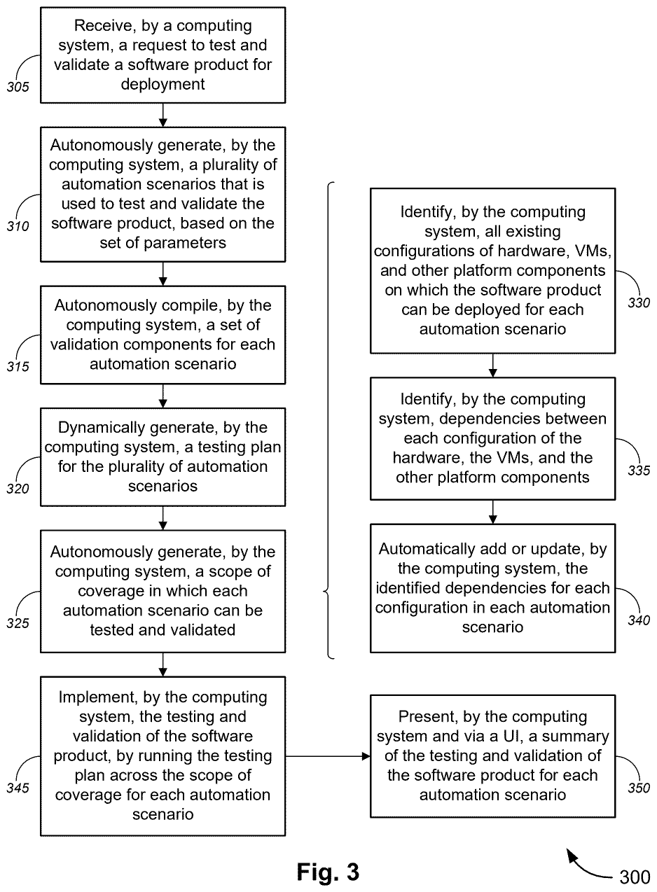

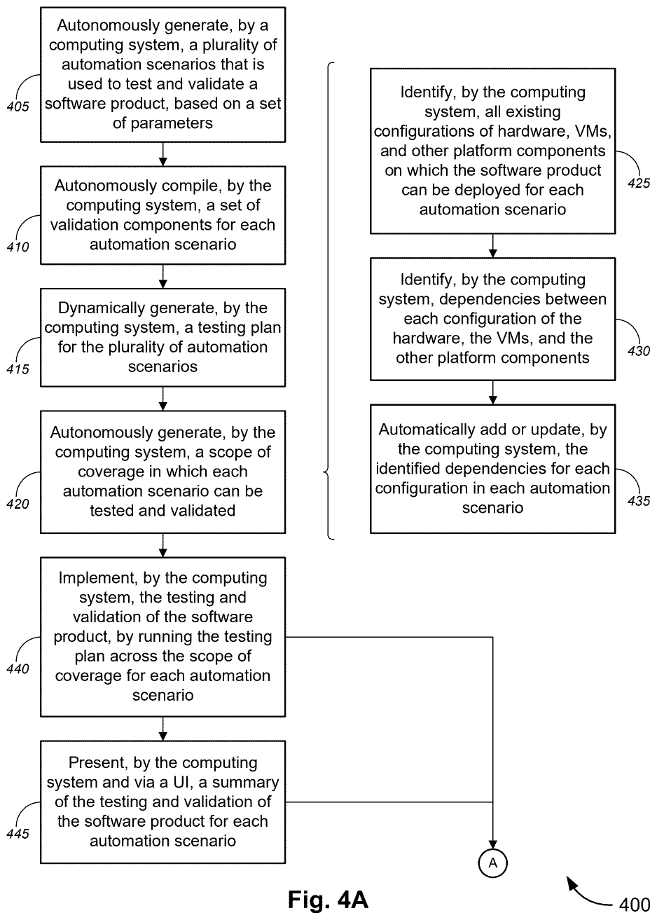

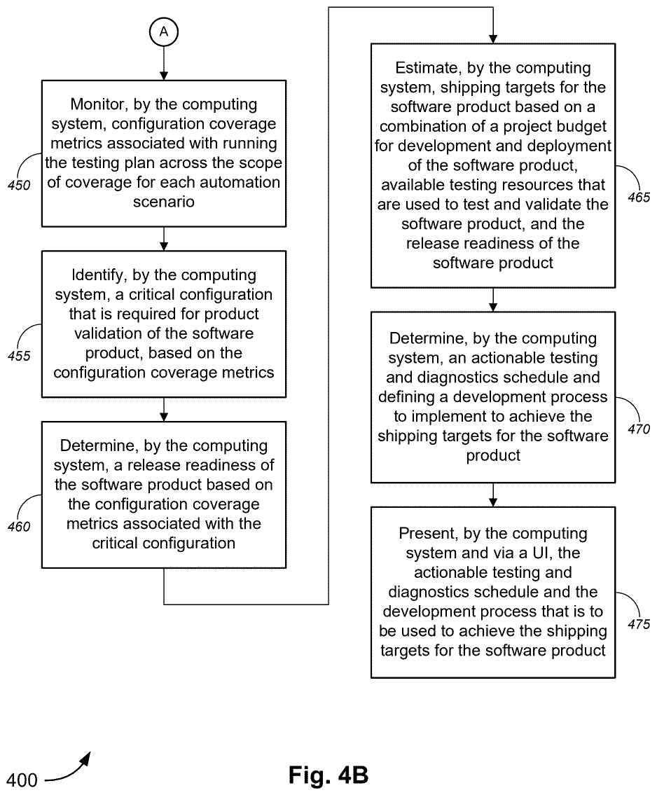

In operation, component-based scheduling system 102 and/or components thereof (collectively, “computing system”) may perform methods for implementing component-based scheduling and release readiness determination, as described in detail with respect to FIGS. 2-4B. For example, example graphical representation 200 as described below with respect to FIG. 2, and methods 300 and 400 as described below with respect to FIGS. 3 and 4A-4B may be applied with respect to the operations of system 100 of FIG. 1.

FIG. 2A depicts an example graphical representation 200A of coverage percentage targets and measurements over time when implementing release readiness determination. FIG. 2B depicts an example simulation process 200B when calculating ship target estimates when implementing release readiness determination. Having good coverage of core configurations is important to ensure the quality of a software product. Determining the right ship target can be challenging, however. For example, a ship target that is set too high may be unrealistic because of limited hardware testing capacity and testing resources. On the other hand, if the target is set too low, the software product is put at great risk of failure.

Validation configurations are categorized as core and secondary configurations. Because the combination of hardware generation, computing hardware, and VM size is related to a majority of deployment failures, hardware generation, computing hardware, and VM size are considered to be core configurations that require high combinatorial coverage in the validation of the software product. Low combinatorial coverage of these core configurations exposes software products to huge risk and therefore should block the release of the software product. Other service configurations that are less likely to cause regressions, such as AN and fast SSD configurations that do not often cause failures in host OS deployments, are considered to be secondary configurations. Secondary configurations are evaluated with a focus on univariate coverage.

There are three primary categories of coverage measures: (1) Combinatorial Configuration Coverage (“CCC”); (2) business value (or BizVal) Combinatorial Configuration Coverage (“BCCC”); and (3) Univariate Configuration Coverage (“UCC”). CCC assesses the coverage of core configurations involving new hardware or VM SKUs. BCCC evaluates the coverage of core configurations with existing hardware or VM SKUs. The objective is to cover all new hardware/VM SKUs, as they are likely to carry high risk. For existing hardware/VM SKUs, coverage is focused on those with both high risk and high revenue impact. UCC measures the coverage of secondary configurations. While CCC and BCCC serve as key indicators for release readiness, UCC assists in decision-making without being a primary readiness indicator.

Assessment of validation coverage centers around the combinatorial coverage of core configurations. Distinct combinatorial coverage metrics for two primary types of hardware and VM SKUs are established: (a) existing SKUs and (b) new SKUs. These combinatorial coverage measures play a crucial role as indicators for release readiness. Additionally, univariate coverage is defined for secondary configurations. While not the primary readiness indicator, secondary configurations provide valuable insights to aid decision-making. As used herein, new SKUs refer to computing hardware or VM SKUs that newly appeared in the fleet but are still in private preview (without public pricing). These SKUs are much riskier than the existing SKUs as they have barely been validated in the fleet. This is especially true for new VM SKUs running on an existing Hardware SKU because they are launched into production without the OS being notified. The BizVal for new SKUs are also hard to determine due to lack of public pricing. For this group of SKUs, each is tested at least once, and CCC is used as the main coverage measure. CCC is calculated as the percentage of configurations that have been validated. Existing SKUs have lower risks than new SKUs. Instead of testing all existing SKUs, the testing for more important SKUs is prioritized. To account for the importance of a SKU, BCCC is used to assess the validation coverage of the existing SKUs. BizVal is an estimate of the revenue impact of a configuration. BCCC is calculated as the percentage of total Biz Val that comes from the validated configurations. A higher BCCC the important test scenarios are being targeted. The risks associated with secondary configurations are often much lower than for the core configurations. Therefore, it is not necessary to focus on a high combinatorial coverage for these secondary configurations. Instead, UCC is used to measure how well these secondary configurations are covered during validation. UCC is calculated as the percentage of possible values validated for a certain configuration.

As used herein, a fleet refers to multiple computing entities. Each computing entity of the fleet of computing entities has a specific configuration, which may be different from configurations for other computing entities in the fleet. It is advantageous to test the computing entities, before being deployed (e.g., to an end user, a service provider, etc.), to identify the potential of the computing entities to fail (e.g., to become unresponsive or experience degraded performance) and to address the causes (or potential causes) of the failures. As used herein, coverage percentage refers to a percentage of configurations of hardware and software configurations and/or components, out of all possible configurations of core hardware and software configurations and/or components that are used when deploying a software product, that are to be tested and validated for each of the targets.

Referring to FIG. 2A, example graphical representation 200A includes various coverage percentage targets, including ship target 205, aspirational target 210, validation scope coverage 215 (at 100%), and fleet-wide coverage 220. The ship target 205 (denoted in FIG. 2A by the short, dashed line) corresponds to a realistic target for coverage percentage that can be achieved based on the limited time and resources available. The ship target 205 accounts for practical constraints during the validation process. The aspirational target 210 (denoted in FIG. 2A by the long, dashed line) corresponds to the desired target after excluding untestable configurations, and reflects what a service provider aims to achieve. The validation scope coverage 215 (denoted in FIG. 2A by the dot-dashed line) corresponds to the maximum achievable coverage (100%) for a service. This can only be achieved if all applicable configurations are validated. However, many configurations are untestable due to various reasons such as insufficient hardware testing capacity or VM quota for a certain test subscription. Fleet-wide coverage (denoted in FIG. 2A by the dot-double dashed line) corresponds to overage that aims to validate all possible configurations available in the fleet. However, depending on the type of services being validated, fleet-wide coverage may not always be necessary, as not all configurations are supported by a given service. Projected coverage 225 corresponds to an estimated coverage over time (e.g., over multiple weeks, months, or years). To achieve the ship target 205, week-over-week (“WOW”) stage targets 230a-230d are set to monitor the progress of the coverage. If the actual coverage 235 is lower than the WoW stage target, coverage gap analysis (“CGA”) is used to identify a root cause of the validation gap.

In examples, the ship target 205 is calculated based on the following inputs: (1) validation scope; (2) validation duration (D); (3) test execution rate (R); (4) hardware testing capacity; and (5) model parameter (ε). The validation scope defines the scope of configurations required for validation. The validation duration (D) is the number of days allocated for validation efforts. The test execution rate (R) is the number of tests that can be performed per day. The hardware testing capacity is the amount of resources available in the test environment for testing a certain configuration. The model parameter (ε) is a parameter that indicates the rate of exploration compared with exploitation in the AI model. For example, an ε value of 0.4 indicates that 40% of the AI model recommendation output relies on random exploration. By default, the value of ε is set to 0.5.

For estimating CCC ship targets, new SKUs are prioritized as the most important configurations for testing as soon as they are detected. Given the limited number of new SKUs, the assumption is that there will be sufficient time to test all of them. Therefore, there are no time or budget constraints associated with these configurations. The following steps are used to calculate the CCC ship target for new SKUs: (A) the number of configurations (with new SKUs) within the validation scope (N_{vs_new}) is estimated; (B) the number of configurations that do not have hardware testing capacity (N_{untestable_new}) is estimated; and (C) the ship target estimate is calculated as:

$$\frac{{N}_{v {s}_{-} n e w} - {N}_{untestable\_new}}{{N}_{v {s}_{-} n e w}} \qquad ( Eqn . l )$$

For estimating BCCC ship targets, existing SKUs are validated with the new SKUs in parallel. The following steps are used to calculate the BCCC ship target for existing SKUs: (A) the number of configurations (with existing SKUs) within the validation scope (Nᵥₛ) is estimated; (B) the number of configurations that do not have hardware testing capacity (N_{untestable}) is estimated; (C) the untestable configurations are removed, and the number of configurations that are recommended by the AI model (Nₑ) is estimated and will be executed in the component-based scheduling system given the validation duration D and the test execution rate R; and (D) the ship target estimate is calculated as:

$$\frac{{\sum }_{i = 1}^{{N}_{e}} {BizVal}_{i}}{{\sum }_{j = 1}^{{N}_{vs}} {BizVal}_{j}} . \qquad ( Eqn . 2 )$$

Referring to step C for existing SKUs, assuming that the value of ε is set to the default value of 0.5, then R/2 configurations will be randomly selected per day. A configuration with higher BizVal will be selected with higher probability. Given the validation duration D, the total number of configurations recommended by the AI model can be estimated using the simulation process 200B shown in FIG. 2B.

For enforcement of ship targets, given the dynamic nature of the fleet, ship targets are reassessed regularly (e.g., on a weekly or monthly basis) to ensure they remain realistic. Conditions that may trigger the change of ship targets include: (i) changes in hardware testing availability; (ii) new untestable configurations being found; (iii) hardware updates; (iv) changes in test throughput; and/or (v) issues requiring long-term solutions. An example of a change in hardware testing availability includes hardware or VM SKUs that were previously testable in hardware testing becoming unavailable due to increased demand. In some cases, some hardware or VM SKUs do not have hardware testing capacity or VM quota for testing. These newly identified untestable configurations can be tracked by bugs for release readiness reviews. For hardware updates new SKUs are introduced and/or old SKUs are phased out. An example of a change in test throughput includes a goal of having 100 configurations per day, but the infrastructure limitations allow only 10 configurations per day. Regarding issues requiring long-term solutions, unexpected test infrastructure issues may arise; some require long-term fixes, while others are beyond the scope of the project.

Regarding the WoW stage targets, these targets serve as actionable goals for a software development team to track their progress and ensure alignment with the final ship target for the software product. The WoW stage target is driven by the ship target and the general availability (“GA”) date set by the release manager. The WoW stage target is calculated by dividing the final ship target by the total number of weeks allocated for validation. Consider an example where the ship target is 80%, and 4 weeks is allocated for validation, the WOW stage target would be a 20% improvement in coverage. To drive the actual coverage towards the WOW stage targets and eventually towards the ship target, the following release quality verification (“RQV”) measures are established for both CCC and BCCC: (1) actual coverage (%); and (2) WoW coverage gap. The actual coverage measures the achieved coverage since the validation began, while the WoW coverage gap quantifies the difference between the WOW stage target and the actual coverage. If this gap is positive, it will be flagged. In examples, configuration coverage is used as one of the indicators for release readiness. The suggested steps to follow to make a release readiness decision include the following. If the final ship targets are met, the software product can proceed to ship or be released. If there is a coverage gap, the following two scenarios are considered. If the coverage gap is due to high reproduction reliability issues, shipping is blocked and the critical scenarios that require further testing are identified. If the coverage gap is due to unforeseen test infrastructure issues, the software product may be allowed to ship or be released with an awareness of potential risks associated with untested configurations during validation.

FIG. 3 depicts an example method 300 for implementing component-based scheduling. With reference to FIG. 3, the operations of example method 300 may be performed by a computing system, which includes a component-based scheduling system (e.g., component-based scheduling system 102 of FIG. 1), and/or components of the computing system.

In the example method 300 of FIG. 3, at operation 305, a computing system receives a request (e.g., request 120 of FIG. 1) to test and validate a software product (e.g., software product 128 of FIG. 1) for deployment. In some examples, the request includes a set of parameters (e.g., parameters 122 of FIG. 1) to be used when testing and validating the software product.

At operation 310, the computing system autonomously generates a plurality of automation scenarios (e.g., automation scenarios 132a-132x of FIG. 1) that is used to test and validate the software product, based on the set of parameters. At operation 315, the computing system autonomously compiles a set of validation components (e.g., schema components 140a-140k of FIG. 1) for each automation scenario. In some cases, one or more validation components that are shared across multiple automation scenarios are reused for each of the multiple automation scenarios across which the one or more validation components are shared.

At operation 320, the computing system dynamically generates a testing plan (e.g., testing plan(s) 144 of FIG. 1) for the plurality of automation scenarios. At operation 325, the computing system autonomously generates a scope of coverage in which each automation scenario can be tested and validated. In some cases, autonomously generating the scope of coverage (at operation 325) includes the computing system identifying all existing configurations of hardware, VMs, and other platform components on which the software product can be deployed for each automation scenario (at operation 330). In some examples, hardware and VMs that are used to deploy the software product that have not yet been registered are automatically identified and registered. Alternatively or additionally, autonomously generating the scope of coverage (at operation 325) (further) includes the computing system identifying dependencies between each configuration of the hardware, the VMs, and the other platform components (at operation 335). Alternatively or additionally, autonomously generating the scope of coverage (at operation 325) (further) includes the computing system automatically adding or updating the identified dependencies for each configuration in each automation scenario (at operation 340).

In some cases, the other platform components include at least one of an OS, software, software applications, or supporting resources. In some instances, autonomously generating the scope of coverage in which each automation scenario can be tested and validated (at operation 325) is performed using an AI model (e.g., AI model(s) 154 of FIG. 1) that is trained to recommend a plurality of configurations of hardware, VMs, and other platform components based on a selection of combinatorial attributes (e.g., combinatorial attributes 156 of FIG. 1). In some examples, the combinatorial attributes include two or more of a number of generations of the hardware associated with the VM to launch, hardware SKUs, VM sizes, a container-based AN being enabled or disabled, RDMA features being enabled or disabled, a fast SSD-based storage being enabled or disabled, an XIO storage being deployed, an image publisher, an image offer, or an image SKU.

At operation 345, the computing system implements the testing and validation of the software product, in some cases, by running the testing plan across the scope of coverage for each automation scenario. At operation 350, the computing system presents, via a UI (e.g., UI 116 of FIG. 1), a summary (e.g., results summary 150 of FIG. 1) of the testing and validation of the software product for each automation scenario. In examples, the summary includes at least one of a number of action steps implemented for that automation scenario, a number of launches implemented for that automation scenario, a number of SKUs launched for that automation scenario, or a number of generations of the hardware associated with the VM that are launched for that automation scenario. In some examples, the UI provides at least one of first options to view individual launches, second options to select one or more generations for a breakdown of the SKUs launched, or third options to view hardware details for individual launches.

In some examples, the set of parameters includes at least one of platform setup configurations, a listing of eligible hardware for platform setup, VM deployment configurations, a selection of hardware scope to launch, a selection of VM hardware scope to launch, a selection of guest OS scope to launch, a selection or deselection of workload deployment, VM count numbers, a selection of a hardware architecture, a selection of an OS, a selection of a VM storage type, a selection or deselection of an accelerated network implementation, or a selection of a VM creation type. In examples, the set of validation components includes JSON schema components, XML schema components, or YAML schema components. In some cases, the set of validation components for each automation scenario corresponds to a plurality of stages in a validation process. In some instances, the plurality of stages includes setting up resources that are used to run the software product, creating a VM, and running code or scripts on the VM.

In examples, the request to test and validate the software product for deployment is received via the UI. In some cases, the computing system receives, via the UI, a first user input selecting a platform setup that is used to generate the plurality of automation scenarios. Alternatively or additionally, the computing system receives, via the UI, a second user input selecting or creating one or more pre-VM deployment actions. In some instances, the one or more pre-VM deployment actions include at least one of deploying a monitoring service that monitors deployment of the VM, deploying a hot restart for a hypervisor for a platform on which the VM is deployed to run the software product, deploying a hot patch to implement security updates, deploying updates to the VM, or initiating live migration of the VM to another node. Alternatively or additionally, the computing system receives, via the UI, a third user input selecting or creating one or more post-VM deployment actions. In some cases, the one or more post-VM deployment actions include at least one of deploying a first I/O agent for a first OS, deploying a second I/O agent for a second OS, or stopping deployment of the monitoring service. In some examples, the plurality of automation scenarios each includes the platform setup, the one or more pre-VM deployment actions, the deployment of the VM, and the one or more post-VM deployment actions.

FIGS. 4A and 4B depict an example method 400 for implementing component-based scheduling and release readiness determination. Referring to FIGS. 4A and 4B, the operations of example method 400 may be performed by a computing system, which includes a component-based scheduling system (e.g., component-based scheduling system 102 of FIG. 1), and/or components of the computing system. Method 400 of FIG. 4A continues onto FIG. 4B following the circular marker denoted, “A.”

In the example method 400 of FIG. 4, at operation 405, a computing system autonomously generates a plurality of automation scenarios (e.g., automation scenarios 132a-132x of FIG. 1) that is used to test and validate a software product (e.g., software product 128 of FIG. 1), based on a set of parameters. At operation 410, the computing system autonomously compiles a set of validation components (e.g., schema components 140a-140k of FIG. 1) for each automation scenario. In some cases, one or more validation components that are shared across multiple automation scenarios are reused for each of the multiple automation scenarios across which the one or more validation components are shared.

At operation 415, the computing system dynamically generates a testing plan (e.g., testing plan(s) 144 of FIG. 1) for the plurality of automation scenarios. At operation 420, the computing system autonomously generates a scope of coverage in which each automation scenario can be tested and validated. In some cases, autonomously generating the scope of coverage (at operation 420) includes the computing system identifying all existing configurations of hardware, VMs, and other platform components on which the software product can be deployed for each automation scenario (at operation 425). In some examples, hardware and VMs that are used to deploy the software product that have not yet been registered are automatically identified and registered. Alternatively or additionally, autonomously generating the scope of coverage (at operation 420) (further) includes the computing system identifying dependencies between each configuration of the hardware, the VMs, and the other platform components (at operation 430). Alternatively or additionally, autonomously generating the scope of coverage (at operation 420) (further) includes the computing system automatically adding or updating the identified dependencies for each configuration in each automation scenario (at operation 435).

In some cases, the other platform components include at least one of an OS, software, software applications, or supporting resources. In some instances, autonomously generating the scope of coverage in which each automation scenario can be tested and validated (at operation 420) is performed using an AI model (e.g., AI model(s) 154 of FIG. 1) that is trained to recommend a plurality of configurations of hardware, VMs, and other platform components based on a selection of combinatorial attributes (e.g., combinatorial attributes 156 of FIG. 1). In some examples, the combinatorial attributes include two or more of a number of generations of the hardware associated with the VM to launch, hardware SKUs, VM sizes, a container-based AN being enabled or disabled, RDMA features being enabled or disabled, a fast SSD-based storage being enabled or disabled, an XIO storage being deployed, an image publisher, an image offer, or an image SKU.

At operation 440, the computing system implements the testing and validation of the software product, in some cases, by running the testing plan across the scope of coverage for each automation scenario. In some examples, method 400 either continues onto the process at 445 or continues onto the process at block 450 in FIG. 4B following the circular marker denoted, “A.” At operation 445, the computing system presents, via a UI (e.g., UI 116 of FIG. 1), a summary (e.g., results summary 150 of FIG. 1) of the testing and validation of the software product for each automation scenario. In some examples, method 400 continues onto the process at block 450 in FIG. 4B following the circular marker denoted, “A.”

In examples, the summary includes at least one of a number of action steps implemented for that automation scenario, a number of launches implemented for that automation scenario, a number of SKUs launched for that automation scenario, or a number of generations of the hardware associated with the VM that are launched for that automation scenario. In some examples, the UI provides at least one of first options to view individual launches, second options to select one or more generations for a breakdown of the SKUs launched, or third options to view hardware details for individual launches.

In some examples, the set of parameters includes at least one of platform setup configurations, a listing of eligible hardware for platform setup, VM deployment configurations, a selection of hardware scope to launch, a selection of VM hardware scope to launch, a selection of guest OS scope to launch, a selection or deselection of workload deployment, VM count numbers, a selection of a hardware architecture, a selection of an OS, a selection of a VM storage type, a selection or deselection of an accelerated network implementation, or a selection of a VM creation type. In examples, the set of validation components includes JSON schema components, XML schema components, or YAML schema components. In some cases, the set of validation components for each automation scenario corresponds to a plurality of stages in a validation process. In some instances, the plurality of stages includes setting up resources that are used to run the software product, creating a VM, and running code or scripts on the VM.

In examples, the request to test and validate the software product for deployment is received via one of the UI or an API (e.g., API(s) 112 of FIG. 1). In some cases, the computing system receives, via the one of the UI or the API, a first user input selecting a platform setup that is used to generate the plurality of automation scenarios. Alternatively or additionally, the computing system receives, via the one of the UI or the API, a second user input selecting or creating one or more pre-VM deployment actions. In some instances, the one or more pre-VM deployment actions include at least one of deploying a monitoring service that monitors deployment of the VM, deploying a hot restart for a hypervisor for a platform on which the VM is deployed to run the software product, deploying a hot patch to implement security updates, deploying updates to the VM, or initiating live migration of the VM to another node. Alternatively or additionally, the computing system receives, via the one of the UI or the API, a third user input selecting or creating one or more post-VM deployment actions. In some cases, the one or more post-VM deployment actions include at least one of deploying a first I/O agent for a first OS, deploying a second I/O agent for a second OS, or stopping deployment of the monitoring service. In some examples, the plurality of automation scenarios each includes the platform setup, the one or more pre-VM deployment actions, the deployment of the VM, and the one or more post-VM deployment actions.

At block 450 in FIG. 4B (following the circular marker denoted, “A,” in FIG. 4A), method 400 may include the computing system monitoring configuration coverage metrics (e.g., coverage metrics 162 of FIG. 1) associated with running the testing plan across the scope of coverage for each automation scenario. At operation 455, the computing system identifies a critical configuration that is required for product validation of the software product, based on the configuration coverage metrics. At operation 460, the computing system determines a release readiness of the software product based on the configuration coverage metrics associated with the critical configuration. At operation 465, the computing system estimates shipping targets (e.g., estimated shipping targets 166 of FIG. 1) for the software product based on a combination of a project budget for development and deployment of the software product, available testing resources that are used to test and validate the software product, and the release readiness of the software product. At operation 470, the computing system determines an actionable testing and diagnostics schedule (e.g., actionable schedule 168 of FIG. 1) and defining a development process to implement to achieve the shipping targets for the software product. At operation 475, the computing system presents, via the UI, the actionable testing and diagnostics schedule and the development process that is to be used to achieve the shipping targets for the software product.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

As should be appreciated from the foregoing, the present technology provides multiple technical benefits and solutions to technical problems. For instance, testing and validating software products generally raises multiple technical problems. For example, one technical problem includes a new schema having to be created for each unique configuration that requires validation. This results in a significant amount of unnecessary work and the generation of multiple files. Managing these numerous schemas becomes cumbersome, leading to difficulties in tracing which configurations have been tested and for what specific scenarios. The lack of centralized management and the proliferation of files complicate the validation process and hinder efficient tracking. Moreover, there is a substantial amount of repeated code across different JSON files, different XML files, or different YAML files. Many features or dimensions to be tested share similar stages, leading to redundancy. This repetition not only increases the effort required to maintain and update the schemas but also introduces potential errors and inconsistencies. Shared stages across multiple JSON files, multiple XML files, or multiple YAML files mean that any change in the common stages necessitates updates in all corresponding schemas, further escalating the maintenance workload.

The present technology provides for component-based scheduling and release readiness determination. The present technology provides a more streamlined and centralized approach that enhances traceability, reduces redundant work, and improves the overall efficiency of the validation process. The component-based scheduling revolutionizes the validation process by automating the creation and scheduling of JSON files, XML files, or YAML files required for each validation. Through an API/UI, users can customize their validation scenarios. The component-based scheduling allows users to create new components or reuse existing ones, which translates into JSON stages, XML stages, or YAML stages that can be combined to form new validation scenarios. This approach eliminates duplicated code, ensuring that any changes made to a component are automatically updated across all scenarios that use it. This not only improves traceability, but also significantly reduces the engineering hours needed for making changes. Additionally, the component-based scheduling enhances the coverage of the validation process. It does so by automatically generating the scope in which a scenario can be tested, continuously updating itself with all existing configurations of hardware and their compatible VMs and configurations. This aspect allows users to instantly understand the full scope of validation for a given scenario. Users can then choose to perform specific runs on selected configurations of hardware and VM configurations or schedule a broader set of tests to run continuously. Moreover, the component-based scheduling offers an easy addition of recommendation systems for scenario validation. Users can either manually input their recommendations or utilize AI tools integrated within the component-based scheduling system to generate recommendations for automatic scheduling. This aspect provides flexibility and intelligence, enabling more efficient and effective validation processes. By leveraging AI, the component-based scheduling system can suggest optimal validation scenarios, improving the overall efficiency and thoroughness of the validation process.

In an aspect, the technology relates to a system that executes computer executable instructions that cause the system to perform operations. The operations include receiving a request to test and validate a software product for deployment, the request including a set of parameters to be used when testing and validating the software product; and autonomously generating a plurality of automation scenarios that is used to test and validate the software product, based on the set of parameters. The operations further include autonomously compiling a set of validation components for each automation scenario, wherein one or more validation components that are shared across multiple automation scenarios are reused for each of the multiple automation scenarios across which the one or more validation components are shared. The operations further include dynamically generating a testing plan for the plurality of automation scenarios; and autonomously generating a scope of coverage in which each automation scenario can be tested and validated, including: identifying all existing configurations of hardware, VMs, and other platform components on which the software product can be deployed for each automation scenario, wherein hardware and VMs that are used to deploy the software product that have not yet been registered are automatically identified and registered; identifying dependencies between each configuration of the hardware, the VMs, and the other platform components; and automatically adding or updating the identified dependencies for each configuration in each automation scenario. The operations further include implementing the testing and validation of the software product, by running the testing plan across the scope of coverage for each automation scenario.

In some examples, the set of parameters includes at least one of platform setup configurations, a listing of eligible hardware for platform setup, VM deployment configurations, a selection of hardware scope to launch, a selection of VM hardware scope to launch, a selection of guest OS scope to launch, a selection or deselection of workload deployment, VM count numbers, a selection of a hardware architecture, a selection of an OS, a selection of a VM storage type, a selection or deselection of an accelerated network implementation, or a selection of a VM creation type. In some cases, the set of validation components includes JSON schema components, XML schema components, or YAML schema components. In some instances, the set of validation components for each automation scenario corresponds to a plurality of stages in a validation process, the plurality of stages including setting up resources that are used to run the software product, creating a VM, and running code or scripts on the VM.

In examples, the request to test and validate the software product for deployment is received via one of a UI or an API. The operations further include: receiving, via the one of the UI or the API, a first user input selecting a platform setup that is used to generate the plurality of automation scenarios; receiving, via the one of the UI or the API, a second user input selecting or creating one or more pre-VM deployment actions, wherein the one or more pre-VM deployment actions include at least one of deploying a monitoring service that monitors deployment of the VM, deploying a hot restart for a hypervisor for a platform on which the VM is deployed to run the software product, deploying a hot patch to implement security updates, deploying updates to the VM, or initiating live migration of the VM to another node; and receiving, via the one of the UI or the API, a third user input selecting or creating one or more post-VM deployment actions, wherein the one or more post-VM deployment actions include at least one of deploying a first I/O agent for a first OS, deploying a second I/O agent for a second OS, or stopping deployment of the monitoring service. In some cases, the plurality of automation scenarios each includes the platform setup, the one or more pre-VM deployment actions, the deployment of the VM, and the one or more post-VM deployment actions.

In some examples, the operations further include presenting, via a UI, a summary of the testing and validation of the software product for each automation scenario. In some instances, the summary include at least one of a number of action steps implemented for that automation scenario, a number of launches implemented for that automation scenario, a number of SKUs launched for that automation scenario, or a number of generations of the hardware associated with the VM that are launched for that automation scenario. In some cases, the UI provides at least one of first options to view individual launches, second options to select one or more generations for a breakdown of the SKUs launched, or third options to view hardware details for individual launches.

In examples, the other platform components include at least one of an OS, software, software applications, or supporting resources. In some cases, autonomously generating the scope of coverage in which each automation scenario can be tested and validated is performed using an AI model that is trained to recommend a plurality of configurations of hardware, VMs, and other platform components based on a selection of combinatorial attributes. In some instances, the combinatorial attributes include two or more of a number of generations of the hardware associated with the VM to launch, hardware SKUs, VM sizes, a container-based AN being enabled or disabled, RDMA features being enabled or disabled, a fast SSD-based storage being enabled or disabled, a data storage system combining SSDs and HDDs into a single storage pool (e.g., XIO storage) being deployed, an image publisher, a group of related images created by the image publisher (e.g., image offer), or a component of a VM image (e.g., image SKU).

In another aspect, the technology relates to a computer-implemented method, including receiving, by a computing system, a request to test and validate a software product for deployment, the request including a set of parameters to be used when testing and validating the software product; and autonomously generating, by the computing system, a plurality of automation scenarios that is used to test and validate the software product, based on the set of parameters. The method further include autonomously compiling, by the computing system, a set of validation components for each automation scenario, wherein one or more validation components that are shared across multiple automation scenarios are reused for each of the multiple automation scenarios across which the one or more validation components are shared. The method further include dynamically generating, by the computing system, a testing plan for the plurality of automation scenarios; and autonomously generating, by the computing system, a scope of coverage in which each automation scenario can be tested and validated, including: identifying, by the computing system, all existing configurations of hardware, VMs, and other platform components on which the software product can be deployed for each automation scenario, wherein hardware and VMs that are used to deploy the software product that have not yet been registered are automatically identified and registered; identifying, by the computing system, dependencies between each configuration of the hardware, the VMs, and the other platform components; and automatically adding or updating, by the computing system, the identified dependencies for each configuration in each automation scenario. The method further include implementing, by the computing system, the testing and validation of the software product, by running the testing plan across the scope of coverage for each automation scenario.

In some examples, the set of parameters includes at least one of platform setup configurations, a listing of eligible hardware for platform setup, VM deployment configurations, a selection of hardware scope to launch, a selection of VM hardware scope to launch, a selection of guest OS scope to launch, a selection or deselection of workload deployment, VM count numbers, a selection of a hardware architecture, a selection of an OS, a selection of a VM storage type, a selection or deselection of an accelerated network implementation, or a selection of a VM creation type. In some cases, the set of validation components includes JSON schema components, XML schema components, or YAML schema components. In some instances, the set of validation components for each automation scenario corresponds to a plurality of stages in a validation process, the plurality of stages including setting up resources that are used to run the software product, creating a VM, and running code or scripts on the VM.

In examples, the request to test and validate the software product for deployment is received via a UI. The method further includes: receiving, by the computing system and via the UI, a first user input selecting a platform setup that is used to generate the plurality of automation scenarios; receiving, by the computing system and via the UI, a second user input selecting or creating one or more pre-VM deployment actions, wherein the one or more pre-VM deployment actions include at least one of deploying a monitoring service that monitors deployment of the VM, deploying a hot restart for a hypervisor for a platform on which the VM is deployed to run the software product, deploying a hot patch to implement security updates, deploying updates to the VM, or initiating live migration of the VM to another node; and receiving, by the computing system and via the UI, a third user input selecting or creating one or more post-VM deployment actions, wherein the one or more post-VM deployment actions include at least one of deploying a first I/O agent for a first OS, deploying a second I/O agent for a second OS, or stopping deployment of the monitoring service.

In some examples, the plurality of automation scenarios each includes the platform setup, the one or more pre-VM deployment actions, the deployment of the VM, and the one or more post-VM deployment actions. In some cases, the method further includes presenting, by the computing system and via a UI, a summary of the testing and validation of the software product for each automation scenario. In some instances, the summary includes at least one of a number of action steps implemented for that automation scenario, a number of launches implemented for that automation scenario, a number of SKUs launched for that automation scenario, or a number of generations of the hardware associated with the VM that are launched for that automation scenario. In examples, the UI provides at least one of first options to view individual launches, second options to select one or more generations for a breakdown of the SKUs launched, or third options to view hardware details for individual launches.

In examples, the other platform components include at least one of an OS, software, software applications, or supporting resources. In some cases, autonomously generating the scope of coverage in which each automation scenario can be tested and validated is performed using an AI model that is trained to recommend a plurality of configurations of hardware, VMs, and other platform components based on a selection of combinatorial attributes. In some instances, the combinatorial attributes include two or more of a number of generations of the hardware associated with the VM to launch, hardware SKUs, VM sizes, a container-based AN being enabled or disabled, RDMA features being enabled or disabled, a fast SSD-based storage being enabled or disabled, a data storage system combining SSDs and HDDs into a single storage pool (e.g., XIO storage) being deployed, an image publisher, a group of related images created by the image publisher (e.g., image offer), or a component of a VM image (e.g., image SKU).

In yet another aspect, the technology relates to a component-based scheduling system, including a processing system and memory coupled to the processing system. The memory includes computer executable instructions that, when executed by the processing system, causes the component-based scheduling system to perform operations. The operations include autonomously generating a plurality of automation scenarios that is used to test and validate a software product, based on a set of parameters; autonomously compiling a set of validation components for each automation scenario; and dynamically generating a testing plan for the plurality of automation scenarios. The operations further include autonomously generating a scope of coverage in which each automation scenario can be tested and validated, including: identifying all existing configurations of hardware, VMs, and other platform components on which the software product can be deployed for each automation scenario, wherein hardware and VMs that are used to deploy the software product that have not yet been registered are automatically identified and registered; identifying dependencies between each configuration of the hardware, the VMs, and the other platform components; and automatically adding or updating the identified dependencies for each configuration in each automation scenario. The operations further include implementing the testing and validation of the software product, by running the testing plan across the scope of coverage for each automation scenario; monitoring configuration coverage metrics associated with running the testing plan across the scope of coverage for each automation scenario; and identifying a critical configuration that is required for product validation of the software product, based on the configuration coverage metrics. The operations further include determining a release readiness of the software product based on the configuration coverage metrics associated with the critical configuration; and estimating shipping targets for the software product based on a configuration of a project budget for development and deployment of the software product, available testing resources that are used to test and validate the software product, and the release readiness of the software product. The operations further include determining an actionable testing and diagnostics schedule and defining a development process to implement to achieve the shipping targets for the software product; and presenting the actionable testing and diagnostics schedule and the development process that is to be used to achieve the shipping targets for the software product.

In some examples, the other platform components include at least one of an OS, software, software applications, or supporting resources. In some cases, autonomously generating the scope of coverage in which each automation scenario can be tested and validated is performed using an AI model that is trained to recommend a plurality of configurations of hardware and VMs based on a selection of combinatorial attributes. In some instances, the combinatorial attributes include two or more of a number of generations to launch, hardware SKUs, VM sizes, containers being enabled or disabled, RDMA being enabled or disabled, a SSD-based storage being deployed, a data storage system combining SSDs and HDDs into a single storage pool (e.g., XIO storage) being deployed, an image publisher, a group of related images created by the image publisher (e.g., image offer), or a component of a VM image (e.g., image SKU).

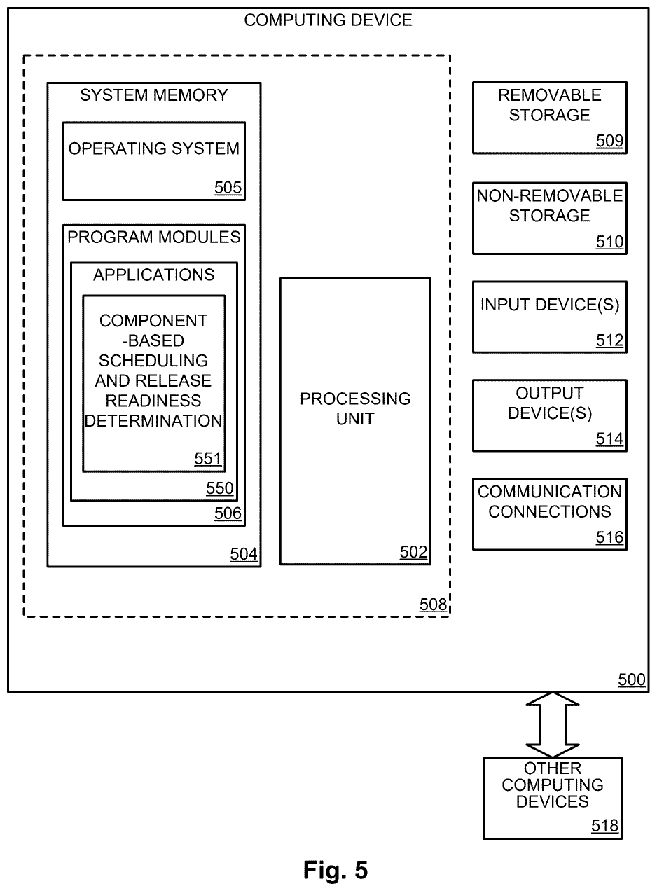

FIG. 5 depicts a block diagram illustrating physical components (i.e., hardware) of a computing device 500 with which examples of the present disclosure may be practiced. The computing device components described below may be suitable for a client device implementing the component-based scheduling and release readiness determination, as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as component-based scheduling and release readiness determination 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities of the claimed subject matter. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIGS. 3-4B, or one or more operations of the system(s) and/or apparatus(es) as described with respect to FIGS. 1 and 2, or the like. Other program modules that may be used in accordance with examples of the present disclosure may include applications such as electronic mail and contacts applications, word processing applications, spreadsheet applications, database applications, slide presentation applications, drawing or computer-aided application programs, AI applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features of the claimed subject matter are ascribed to different embodiments, it should be appreciated that the features of the claimed subject matter described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features of the claimed subject matter (both structural and methodological) are intended to be selectively rearranged, included, or omitted to produce an example or embodiment with a particular set of features of the claimed subject matter. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system that executes computer executable instructions that cause the system to perform operations comprising:
receiving a request to test and validate a software product for deployment, the request including a set of parameters to be used when testing and validating the software product;
autonomously generating a plurality of automation scenarios that is used to test and validate the software product, based on the set of parameters;
autonomously compiling a set of validation components for each automation scenario, wherein one or more validation components that are shared across multiple automation scenarios are reused for each of the multiple automation scenarios across which the one or more validation components are shared;
dynamically generating a testing plan for the plurality of automation scenarios;
autonomously generating a scope of coverage in which each automation scenario can be tested and validated, including:
identifying all existing configurations of hardware, virtual machines (“VMs”), and other platform components on which the software product can be deployed for each automation scenario, wherein hardware and VMs that are used to deploy the software product that have not yet been registered are automatically identified and registered;
identifying dependencies between each configuration of the hardware, the VMs, and the other platform components; and
automatically adding or updating the identified dependencies for each configuration in each automation scenario; and
implementing the testing and validation of the software product, by running the testing plan across the scope of coverage for each automation scenario.

2. The system of claim 1, wherein the set of parameters includes at least one of platform setup configurations, a listing of eligible hardware for platform setup, VM deployment configurations, a selection of hardware scope to launch, a selection of VM hardware scope to launch, a selection of guest operating system (“OS”) scope to launch, a selection or deselection of workload deployment, VM count numbers, a selection of a hardware architecture, a selection of an OS, a selection of a VM storage type, a selection or deselection of an accelerated network implementation, or a selection of a VM creation type.

3. The system of claim 1, wherein the set of validation components includes Javascript® Object Notation (“JSON”) schema components, extensible Markup Language (“XML”) schema components, or YAML Ain't Markup Language (“YAML”) schema components.

4. The system of claim 1, wherein the set of validation components for each automation scenario corresponds to a plurality of stages in a validation process, the plurality of stages including setting up resources that are used to run the software product, creating a VM, and running code or scripts on the VM.

5. The system of claim 1, wherein the request to test and validate the software product for deployment is received via one of a user interface (“UI”) or an application programming interface (“API”), wherein the operations further comprise:
receiving, via the one of the UI or the API, a first user input selecting a platform setup that is used to generate the plurality of automation scenarios;
receiving, via the one of the UI or the API, a second user input selecting or creating one or more pre-VM deployment actions, wherein the one or more pre-VM deployment actions include at least one of deploying a monitoring service that monitors deployment of the VM, deploying a hot restart for a hypervisor for a platform on which the VM is deployed to run the software product, deploying a hot patch to implement security updates, deploying updates to the VM, or initiating live migration of the VM to another node; and
receiving, via the one of the UI or the API, a third user input selecting or creating one or more post-VM deployment actions, wherein the one or more post-VM deployment actions include at least one of deploying a first input/output (“I/O”) agent for a first OS, deploying a second I/O agent for a second OS, or stopping deployment of the monitoring service.

6. The system of claim 5, wherein the plurality of automation scenarios each includes the platform setup, the one or more pre-VM deployment actions, the deployment of the VM, and the one or more post-VM deployment actions.

7. The system of claim 1, wherein the operations further comprise:
presenting, via a UI, a summary of the testing and validation of the software product for each automation scenario, the summary including at least one of a number of action steps implemented for that automation scenario, a number of launches implemented for that automation scenario, a number of stock keeping units (“SKUs”) launched for that automation scenario, or a number of generations of the hardware associated with the VM that are launched for that automation scenario, wherein the UI provides at least one of first options to view individual launches, second options to select one or more generations for a breakdown of the SKUs launched, or third options to view hardware details for individual launches.

8. The system of claim 1, wherein the other platform components include at least one of an OS, software, software applications, or supporting resources.

9. The system of claim 8, wherein autonomously generating the scope of coverage in which each automation scenario can be tested and validated is performed using an artificial intelligence (“AI”) model that is trained to recommend a plurality of configurations of hardware, VMs, and other platform components based on a selection of combinatorial attributes, the combinatorial attributes including two or more of a number of generations of the hardware associated with the VM to launch, hardware SKUs, VM sizes, a container-based accelerated network (“AN”) being enabled or disabled, remote direct memory access (“RDMA”) features being enabled or disabled, a fast solid state drive (“SSD”)-based storage being enabled or disabled, a data storage system combining SSDs and hard disk drives (“HDDs”) into a single storage pool (“XIO storage”) being deployed, an image publisher, a group of related images created by the image publisher (“image offer”), or a component of a VM image (“image SKU”).

10. A computer-implemented method, comprising:
receiving, by a computing system, a request to test and validate a software product for deployment, the request including a set of parameters to be used when testing and validating the software product;
autonomously generating, by the computing system, a plurality of automation scenarios that is used to test and validate the software product, based on the set of parameters;
autonomously compiling, by the computing system, a set of validation components for each automation scenario, wherein one or more validation components that are shared across multiple automation scenarios are reused for each of the multiple automation scenarios across which the one or more validation components are shared;
dynamically generating, by the computing system, a testing plan for the plurality of automation scenarios;
autonomously generating, by the computing system, a scope of coverage in which each automation scenario can be tested and validated, including:
identifying, by the computing system, all existing configurations of hardware, virtual machines (“VMs”), and other platform components on which the software product can be deployed for each automation scenario, wherein hardware and VMs that are used to deploy the software product that have not yet been registered are automatically identified and registered;
identifying, by the computing system, dependencies between each configuration of the hardware, the VMs, and the other platform components; and
automatically adding or updating, by the computing system, the identified dependencies for each configuration in each automation scenario; and
implementing, by the computing system, the testing and validation of the software product, by running the testing plan across the scope of coverage for each automation scenario.

11. The computer-implemented method of claim 10, wherein the set of parameters includes at least one of platform setup configurations, a listing of eligible hardware for platform setup, VM deployment configurations, a selection of hardware scope to launch, a selection of VM hardware scope to launch, a selection of guest operating system (“OS”) scope to launch, a selection or deselection of workload deployment, VM count numbers, a selection of a hardware architecture, a selection of an OS, a selection of a VM storage type, a selection or deselection of an accelerated network implementation, or a selection of a VM creation type.

12. The computer-implemented method of claim 10, wherein the set of validation components includes Javascript® Object Notation (“JSON”) schema components, extensible Markup Language (“XML”) schema components, or YAML Ain't Markup Language (“YAML”) schema components.

13. The computer-implemented method of claim 10, wherein the set of validation components for each automation scenario corresponds to a plurality of stages in a validation process, the plurality of stages including setting up resources that are used to run the software product, creating a VM, and running code or scripts on the VM.

14. The computer-implemented method of claim 10, wherein the request to test and validate the software product for deployment is received via a user interface (“UI”), wherein the method further comprises:
receiving, by the computing system and via the UI, a first user input selecting a platform setup that is used to generate the plurality of automation scenarios;
receiving, by the computing system and via the UI, a second user input selecting or creating one or more pre-VM deployment actions, wherein the one or more pre-VM deployment actions include at least one of deploying a monitoring service that monitors deployment of the VM, deploying a hot restart for a hypervisor for a platform on which the VM is deployed to run the software product, deploying a hot patch to implement security updates, deploying updates to the VM, or initiating live migration of the VM to another node; and
receiving, by the computing system and via the UI, a third user input selecting or creating one or more post-VM deployment actions, wherein the one or more post-VM deployment actions include at least one of deploying a first input/output (“I/O”) agent for a first OS, deploying a second I/O agent for a second OS, or stopping deployment of the monitoring service.

15. The computer-implemented method of claim 14, wherein the plurality of automation scenarios each includes the platform setup, the one or more pre-VM deployment actions, the deployment of the VM, and the one or more post-VM deployment actions.

16. The computer-implemented method of claim 10, further comprising:
presenting, by the computing system and via a UI, a summary of the testing and validation of the software product for each automation scenario, the summary including at least one of a number of action steps implemented for that automation scenario, a number of launches implemented for that automation scenario, a number of stock keeping units (“SKUs”) launched for that automation scenario, or a number of generations of the hardware associated with the VM that are launched for that automation scenario, wherein the UI provides at least one of first options to view individual launches, second options to select one or more generations for a breakdown of the SKUs launched, or third options to view hardware details for individual launches.

17. The computer-implemented method of claim 10, wherein the other platform components include at least one of an OS, software, software applications, or supporting resources.

18. The computer-implemented method of claim 17, wherein autonomously generating the scope of coverage in which each automation scenario can be tested and validated is performed using an artificial intelligence (“AI”) model that is trained to recommend a plurality of configurations of hardware, VMs, and other platform components based on a selection of combinatorial attributes, the combinatorial attributes including two or more of a number of generations of the hardware associated with the VM to launch, hardware SKUs, VM sizes, a container-based accelerated network (“AN”) being enabled or disabled, remote direct memory access (“RDMA”) features being enabled or disabled, a fast solid state drive (“SSD”)-based storage being enabled or disabled, a data storage system combining SSDs and hard disk drives (“HDDs”) into a single storage pool (“XIO storage”) being deployed, an image publisher, a group of related images created by the image publisher (“image offer”), or a component of a VM image (“image SKU”).

19. A component-based scheduling system, comprising:
a processing system; and
memory coupled to the processing system, the memory comprising computer executable instructions that, when executed by the processing system, causes the component-based scheduling system to perform operations comprising:
autonomously generating a plurality of automation scenarios that is used to test and validate a software product, based on a set of parameters;
autonomously compiling a set of validation components for each automation scenario;
dynamically generating a testing plan for the plurality of automation scenarios;
autonomously generating a scope of coverage in which each automation scenario can be tested and validated, including:
identifying all existing configurations of hardware, virtual machines (“VMs”), and other platform components on which the software product can be deployed for each automation scenario, wherein hardware and VMs that are used to deploy the software product that have not yet been registered are automatically identified and registered;
identifying dependencies between each configuration of the hardware, the VMs, and the other platform components; and
automatically adding or updating the identified dependencies for each configuration in each automation scenario;
implementing the testing and validation of the software product, by running the testing plan across the scope of coverage for each automation scenario;
monitoring configuration coverage metrics associated with running the testing plan across the scope of coverage for each automation scenario;
identifying a critical configuration that is required for product validation of the software product, based on the configuration coverage metrics;
determining a release readiness of the software product based on the configuration coverage metrics associated with the critical configuration;
estimating shipping targets for the software product based on a configuration of a project budget for development and deployment of the software product, available testing resources that are used to test and validate the software product, and the release readiness of the software product;
determining an actionable testing and diagnostics schedule and defining a development process to implement to achieve the shipping targets for the software product; and
presenting the actionable testing and diagnostics schedule and the development process that is to be used to achieve the shipping targets for the software product.

20. The component-based scheduling system of claim 19, wherein the other platform components include at least one of an OS, software, software applications, or supporting resources, wherein autonomously generating the scope of coverage in which each automation scenario can be tested and validated is performed using an artificial intelligence (“AI”) model that is trained to recommend a plurality of configurations of hardware and VMs based on a selection of combinatorial attributes, the combinatorial attributes including two or more of a number of generations to launch, hardware stock keeping units (“SKUs”), VM sizes, containers being enabled or disabled, remote direct memory access (“RDMA”) being enabled or disabled, a solid state drive (“SSD”)-based storage being deployed, a data storage system combining SSDs and hard disk drives (“HDDs”) into a single storage pool (“XIO storage”) being deployed, an image publisher, a group of related images created by the image publisher (“image offer”), or a component of a VM image (“image SKU”).
